(19) United States
(12) Patent Application Publication
(10) Pub. No.: US 2016/0278044 A1
(43) Pub. Date: Sep. 22, 2016

(54) WIRELESS COMMUNICATING APPARATUS

(71) Applicant: Panasonic Intellectual Property Management Co., Ltd., Osaka (JP)

(72) Inventor: Shinichiro NISHIOKA, Osaka (JP)

(21) Appl. No.: 15/048,100

(22) Filed: Feb. 19, 2016

(30) Foreign Application Priority Data
Mar. 18, 2015 (JP) 2015-054504
Dec. 3, 2015 (JP) 2015-236230

(51) Int. Cl. H04W 72/02; H04W 48/16; G06F 3/14; H04W 4/00

(52) U.S. Cl. CPC H04W 72/02; H04W 4/008; H04W 48/16; G06F 3/1431; G06F 3/1454

(57) ABSTRACT

The wireless communicating apparatus of the present disclosure is a wireless communicating apparatus that performs wireless communication with an external device, and includes a wireless communicating device having a plurality of transmission directionalities and capable of switching the transmission directionalities; a display having a plurality of display areas corresponding to the transmission directionalities and displaying information about the external device; and a controller that controls the wireless communicating device and the display. The controller allows the wireless communicating device to transmit a search signal by switching the transmission directionalities and selects one of the transmission directionalities based on a response signal received from the external device, and the display to display the information about the external device in one of the display areas corresponding to the transmission directionality selected.

### BACKGROUND

1. Technical Field

The present disclosure relates to a wireless communicating apparatus.

2. Description of the Related Art

Unexamined Japanese Patent Publication No. 2013-9180 (hereinafter referred to as “PTL 1”) discloses a wireless communicating apparatus that performs wireless communication by establishing communication with an external device selected from a plurality of external devices.

Such a wireless communicating apparatus includes an image sensor, and displays on a display an image obtained by the image sensor. Then, the wireless communicating apparatus establishes communication with an external device selected by a user out of external devices contained in the displayed image. At this time, the display of the wireless communicating apparatus displays the image of the external device over or near which terminal information of the corresponding external device is superimposed. This facilitates selection of an external device by the user.

The wireless communicating apparatus disclosed in PTL 1 first transmits a search signal while switching transmission directionality. Then, the wireless communicating apparatus receives a response signal to the search signal returned from the external device while switching reception directionality of a reception antenna. With this, the wireless communicating apparatus specifies a direction in which received signal strength of the response signal is maximized, and estimates a direction of the external device (i.e., a position or the like). At this time, the above processing is performed to each of the plurality of external devices.

### SUMMARY

The present disclosure provides a wireless communicating apparatus that performs wireless communication with an external device, and includes: a wireless communicating device having a plurality of transmission directionalities and capable of switching the transmission directionalities; a display having a plurality of display areas corresponding to the transmission directionalities and displaying information about the external device; and a controller configured to controls the wireless communicating device and the display. The controller is configured to allow the wireless communicating device to transmit a search signal by switching the transmission directionalities and to select one of the transmission directionalities based on a response signal received from the external device, and the display to display the information about the external device in one of the display areas corresponding to the transmission directionality selected.

### BRIEF DESCRIPTION OF DRAWINGS

FIG. 1 is a schematic diagram for describing a communication attempt of a wireless communicating apparatus according to a first exemplary embodiment with an external device;

FIG. 2 is a block diagram of the wireless communicating apparatus according to the first exemplary embodiment;

FIG. 3 is a block diagram of the external device according to the first exemplary embodiment;

FIG. 4 is a conceptual diagram of transmission and reception of a signal between the wireless communicating apparatus and a first external device in beam forming of sector sweeping according to the first exemplary embodiment;

FIG. 5 is a flowchart illustrating one example of operation of the wireless communicating apparatus according to the first exemplary embodiment;

FIG. 6 is a diagram illustrating a display example of a display according to the first exemplary embodiment;

FIG. 7 is a display example of the display according to the first exemplary embodiment, and is a diagram illustrating an example in which a service selection menu is displayed;

FIG. 8 is a sequence diagram of operation between the wireless communicating apparatus and the external device according to the first exemplary embodiment;

FIG. 9 is a diagram illustrating a display example of the display of when the wireless communicating apparatus according to the first exemplary embodiment is moved; and

FIG. 10 is a block diagram of a wireless communicating apparatus according to a second exemplary embodiment.

### DETAILED DESCRIPTION

Hereinafter, exemplary embodiments will be described in detail with reference to the drawings.

### First Exemplary Embodiment

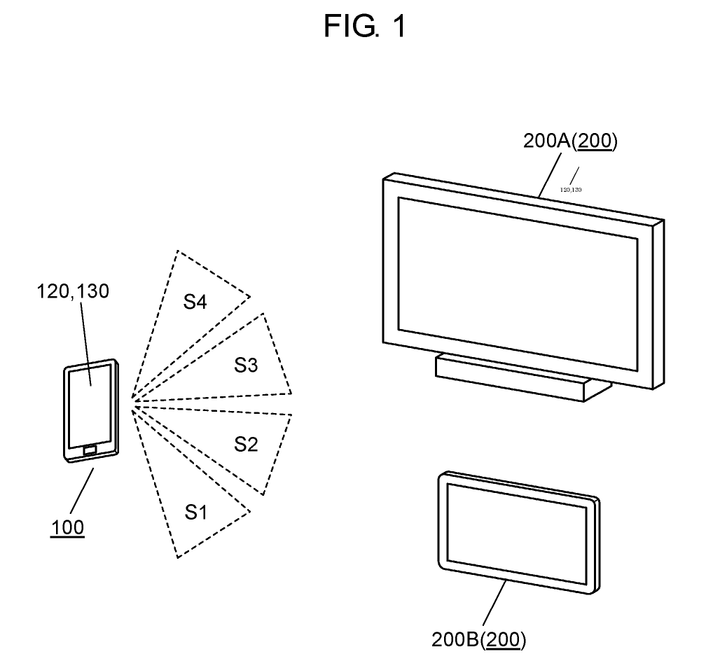

FIG. 1 is a schematic diagram for describing a communication attempt of a wireless communicating apparatus according to a first exemplary embodiment with an external device.

As illustrated in FIG. 1, wireless communicating apparatus 100 of the present exemplary embodiment performs the communication attempt of so called sector sweeping, and estimates directions of a plurality of external devices 200, such as first external device 200A, second external device 200B. Wireless communicating apparatus 100 has a function for displaying terminal information and the like on display 120.

In the following, as wireless communicating apparatus 100, an information processing device is described as an example, such as a mobile phone having an image pick-up sensor such as a camera; however, wireless communicating apparatus 100 is not limited to the information processing device. For example, wireless communicating apparatus 100 may be a pair of glasses including a wireless communicating device and a display.

Specifically, wireless communicating apparatus 100 takes images of first external device 200A, and second external device 200B by the image pick-up sensor. Wireless communicating apparatus 100 displays first external device 200A and second external device 200B imaged in a display that is display 120. At the same time, wireless communicating apparatus 100 estimates positions of first external device 200A and second external device 200B in a taken image, based on respective directions of first external device 200A and second external device 200B estimated by the communication attempt. Then, wireless communicating apparatus 100 displays the terminal information such as an appropriate UI (user interface) on or near first external device 200A and second external device 200B displayed by being superimposed. Thus, wireless communicating apparatus 100 provides a predetermined service to a user via the UI.

In the following description, when a plurality of external devices such as first external device 200A and second external device 200B is not distinguished, hereinafter referred to as “external device 200”, for the purpose of illustration.

### <Configuration of Wireless Communicating Apparatus>

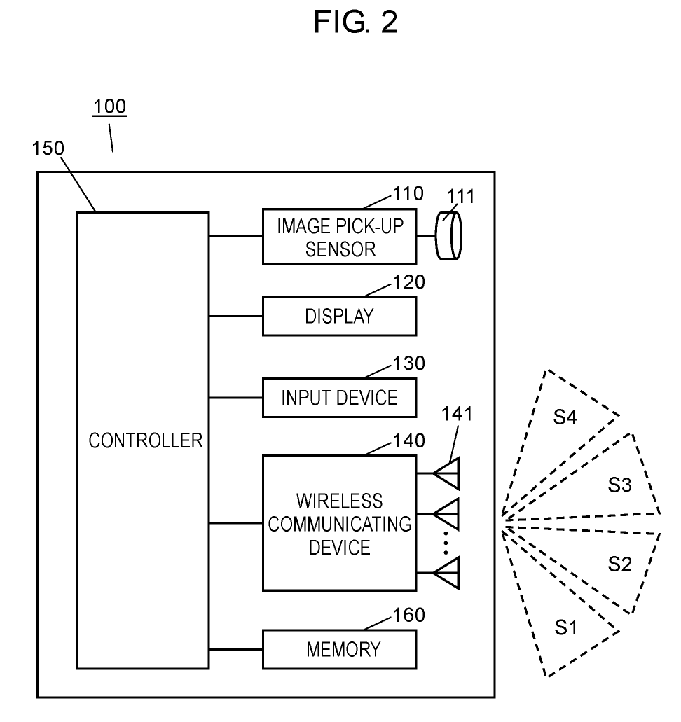

First, a configuration of wireless communicating apparatus 100 will be described with reference to FIG. 2. FIG. 2 is a block diagram of the wireless communicating apparatus according to the first exemplary embodiment.

Wireless communicating apparatus 100 is an information processing device that performs wireless communication with external device 200 (that is, corresponding to other wireless communicating apparatus). For example, wireless communicating apparatus 100 performs highly directional wireless communication in millimeter wave communication using a 60 GHz band.

Specifically, wireless communicating apparatus 100, as illustrated in FIG. 2, includes image pick-up sensor 110, display 120, input device 130, wireless communicating device 140, controller 150, memory 160, and the like. Here, when wireless communicating apparatus 100 is a pair of glasses or the like, the eyes of a person correspond to image pick-up sensor 110, so that image pick-up sensor 110 is not included in constituent element.

Wireless communicating apparatus 100 in an example of the present disclosure is, for example, a smartphone. In addition, wireless communicating apparatus 100 operates as a PCP (PBSS Control Point)/AP (Access Point) defined in IEEE802.11ad.

Image pick-up sensor 110 has optical system 111 and an imaging sensor (not illustrated), and is disposed on the casing of wireless communicating apparatus 100 on an opposite side from display 120. Image pick-up sensor 110 performs imaging of an object continuously, that is, performs imaging of a moving image.

Display 120 displays various types of information of wireless communicating apparatus 100. For example, display 120 displays an image taken by image pick-up sensor 110. Display 120 also displays information such as terminal information about external device 200 whose images are taken. Input device 130 receives input operation of the user. Display 120 and input device 130 in the example of the present disclosure are integrally configured together with, for example, a touch panel (touch screen). In FIG. 2, display 120 and input device 130 are separately illustrated.

However, display 120 and input device 130, not limited to be configured to be integrally formed, can be configured to be separately formed. For example, display 120 may be a typical display, and input device 130 may be configured by arrow keys disposed on the casing of wireless communicating apparatus 100.

Wireless communicating device 140 establishes highly directional wireless communication with external device 200 to perform data transmission and the like. That is, wireless communicating device 140 implements a service using wireless communication with external device 200. At this time, wireless communicating device 140 performs data transmission via directional wireless communication such as IEEE802.11ad standard. Specifically, wireless communicating device 140 performs wireless communication, for example, in a frequency band from 57.24 GHz to 65.88 GHz.

Wireless communicating device 140 includes a plurality of communication antennas 141 for communication each having directionality. Each of communication antennas 141 is an antenna for data communication that performs transmission and reception of a high-frequency signal (radiowave). The plurality of communication antennas 141 is configured with, for example, a phased array type antenna, and weighting of each of the communication antennas 141 is changed by setting of a communication parameter. That is, the plurality of communication antennas 141 is configured to change the transmission directionality by changing an antenna pattern depending on the setting of the communication parameter.

Further, wireless communicating device 140 includes an RF transceiver and a baseband processor that are not illustrated. The RF transceiver converts a high-frequency signal received by communication antennas 141 into a baseband signal. In addition, the RF transceiver converts the baseband signal into a high-frequency signal to transmit the converted signal through communication antennas 141. The baseband processor demodulates the baseband signal input from the RF transceiver. In addition, the baseband processor converts a signal to be transmitted into a baseband signal to output the converted signal to the RF transceiver.

Controller 150 performs calculation based on data input via input device 130 and the like, and outputs a calculation result to perform various types of control of wireless communicating apparatus 100. Controller 150 is configured by a system LSI (Large Scale Integration). Controller 150 includes, for example, a CPU (Central Processing Unit) and a GPU (Graphics Processing Unit).

In addition, controller 150 performs a communication attempt by wireless communicating device 140. Specifically, controller 150 performs a communication attempt that is in accordance with beam forming protocol of sector sweeping defined in IEEE802.11ad standard.

The system LSI constituting controller 150, depending on a difference of a degree of integration, may be configured by an IC (Integrated Circuit), a system LSI, a super LSI, or an ultra LSI. The system LSI may be implemented by a dedicated circuit or a general purpose processor. Further, the system LSI may be configured by a FPGA (Field Programmable Gate Array) that may be programmed after production, or a configurable processor whose connection and setting of a circuit cell within the processor is reconfigurable. Wireless communicating apparatus 100, depending on advance in semiconductor technology or a different technology derived therefrom, may be a component in place of the system LSI, the component being integrated based on a different technology of circuit integration (e.g., biotechnology or the like).

Memory 160 stores various types of data. Memory 160 stores, for example, a plurality of communication parameters that decides the antenna pattern of wireless communicating device 140 and a sector ID corresponding to each of the communication parameters in association with each other. Each of the communication parameters is, for example, a weighting pattern of each of the communication antennas 141. Memory 160 is a storage medium such as a semiconductor memory, for example, a FLASH memory, a ferroelectric memory, and an HDD (Hard Disc Drive).

### <Configuration of External Device>

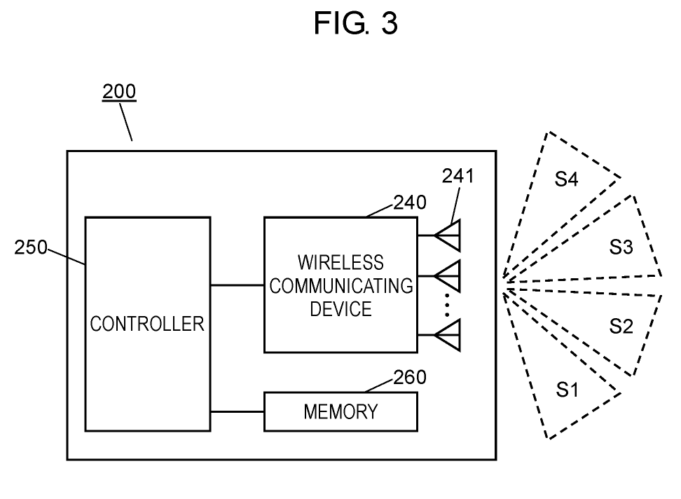

Next, a configuration of external device 200 will be described with reference to FIG. 3. FIG. 3 is a block diagram of the external device according to the first exemplary embodiment.

External device 200 is an information processing device capable of wireless communication with wireless communicating apparatus 100. External device 200 performs highly directional wireless communication by millimeter wave communication using a 60 GHz band.

Specifically, external device 200, as illustrated in FIG. 3, includes wireless communicating device 240, controller 250, memory 260, and the like.

External device 200 in the example of the present disclosure is, for example, a television or a tablet. External device 200, other than wireless communicating device 240, controller 250 and memory 260, also includes a configuration for exerting an original function of the device. External device 200 operates as an STA (Station) defined in IEEE802.11ad standard.

Wireless communicating device 240 establishes highly directional wireless communication with wireless communicating apparatus 100 to perform data transmission and the like. That is, wireless communicating device 240 implements a service using wireless communication with wireless communicating apparatus 100.

Wireless communicating device 240 further includes a plurality of communication antennas 241 for communication each having directionality.

Since the basic configuration of wireless communicating device 240 is the same as wireless communicating device 140 of wireless communicating apparatus 100, a detailed description will be omitted.

Controller 250, which is the same as controller 150 of wireless communicating apparatus 100, is configured by a system LSI. Controller 250 has, for example, a CPU. Controller 250 performs calculation based on data input, and outputs a calculation result, to perform various types of control of external device 200.

Controller 250, as a response to the communication attempt of wireless communicating apparatus 100, performs the communication attempt via wireless communicating device 240. Specifically, controller 250 performs the communication attempt that is in accordance with beam forming protocol of sector sweeping defined in IEEE802.11ad standard. At this time, controller 250 performs the communication attempt including a best sector ID to be described later as a response signal, to wireless communicating apparatus 100.

Memory 260 stores various types of data. For example, memory 260 stores a plurality of communication parameters that decides an antenna pattern of wireless communicating device 240 and a sector ID corresponding to each of the communication parameters in association with each other. Each of the communication parameters is, for example, a weighting pattern of each of communication antennas 241. Memory 260 is a storage medium such as a semiconductor memory, for example, a FLASH memory, a ferroelectric memory, and an HDD (Hard Disc Drive).

### <Communication Attempt>

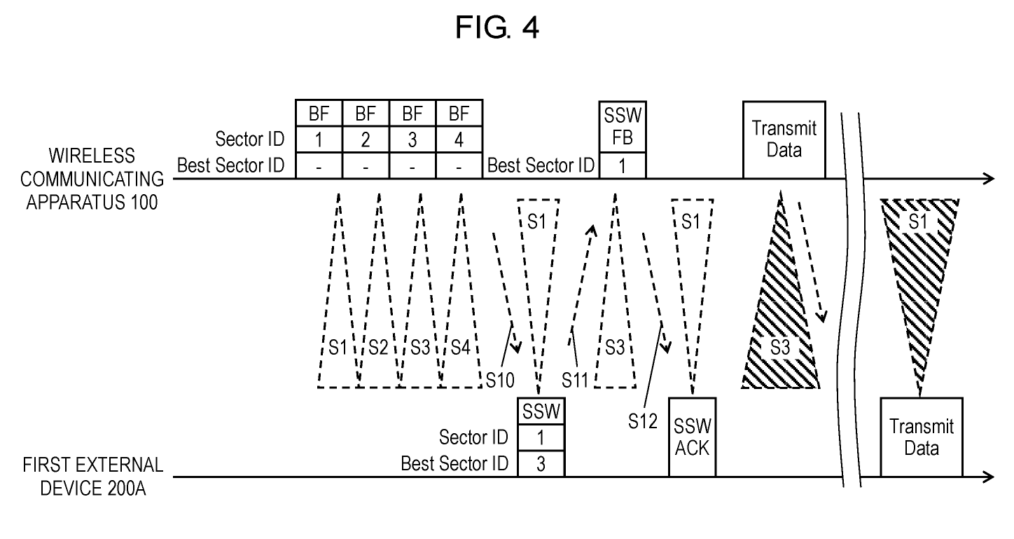

Next, beam forming of sector sweeping is described with reference to FIG. 4. FIG. 4 is a conceptual diagram of transmission and reception of a signal between the wireless communicating apparatus and a first external device in beam forming of sector sweeping according to the first exemplary embodiment.

As illustrated in FIG. 4, first, wireless communicating apparatus 100 switches the transmission directionalities each configured with a sector to sequentially transmit a search signal. Specifically, controller 150 allows wireless communicating device 140 to sequentially transmit the search signal toward a plurality of sectors.

In the following, a case will be described in which the sector is divided into, for example, four sectors of sector 1 to sector 4, and the sectors divided are switched to sequentially transmit the search signal. A number of divisions of the sector is set in advance at the time of designing wireless communicating apparatus 100.

That is, as an area to which the search signal can be transmitted from wireless communicating device 140, the sector is divided in advance into first sector S1 to fourth sector S4. At this time, memory 160 stores the communication parameter for transmitting the search signal to each of the sectors. The communication parameter is stored in association with the corresponding sector ID.

Controller 150 refers to contents of memory 160 to sequentially select the sector ID. Controller 150 sets the communication parameter corresponding to the sector ID selected for each selection of the sector ID. Then, controller 150 allows wireless communicating device 140 to transmit the search signal (arrow S10 illustrated in FIG. 4). For example, when sector ID1 is selected, the communication parameter corresponding to sector ID1 is set to wireless communicating device 140. Then, from wireless communicating device 140 toward a direction of first sector S1 corresponding to the transmission directionality, the search signal is transmitted from corresponding communication antenna 141. When each of sector ID2 to sector ID4 is selected, the transmission directionalities are switched to transmit the search signal toward each of directions of second sector S2 to fourth sector S4 from each of corresponding communication antennas 141.

At this time, the search signal to be transmitted from wireless communicating device 140 is configured by a signal (beacon signal) including a frame (beacon frame, BF). The sector ID is included in an area of the sector ID in the frame. That is, the sector ID is included in the search signal to be transmitted from wireless communicating device 140. The sector ID is one example of identification information of the sector.

Then, while wireless communicating device 140 switches the transmission directionalities to sequentially transmit the search signal toward first sector S1 to fourth sector S4, controller 250 of first external device 200A measures reception quality of a signal to be obtained from the search signal received by wireless communicating device 240. Specifically, controller 250 measures reception quality of the search signal by using a received signal strength indicator (RSSI: Received Signal Strength Indicator), a signal-to-noise ratio (SNR: Signal-to-Noise Ratio), and a bit error rate (BER: Bit Error Rate). Thus, normally, controller 250 of first external device 200A selects the sector ID of the search signal of the most satisfactory reception quality as the best sector ID.

Next, controller 250 of first external device 200A allows wireless communicating device 240 to transmit a radiowave including the sector ID selected as the best sector ID, as a response signal (arrow S11 illustrated in FIG. 4). At this time, the response signal should be, for example, a probe request frame to be transmitted to wireless communicating apparatus 100.

In the following, a case will be described in which the best sector ID included in the response signal from first external device 200A is sector ID3.

A function of measuring quality of wireless communication may be implemented as a part of controller 250, or may be implemented by another component. That is, the best sector ID is one example of information about the reception quality of the search signal.

Next, controller 150 of wireless communicating apparatus 100 receives the response signal including the best sector ID from first external device 200A through wireless communicating device 140. This makes it possible to estimate the sector (corresponding to transmission directionality) in which first external device 200A is positioned. That is, it is possible to estimate the direction of first external device 200A from wireless communicating apparatus 100. In this case, in the radiowave of the response signal from first external device 200A, information is included such as terminal information that identifies first external device 200A. Therefore, controller 150 stores the terminal information of first external device 200A and the best sector ID of first external device 200A in association with each other in memory 160.

Thus, when performing subsequent communication with first external device 200A, controller 150 refers to memory 160 to set the communication parameter corresponding to the best sector ID associated with first external device 200A to wireless communicating device 140 as an optimal direction of the transmission directionality. Then, wireless communicating apparatus 100 switches to the transmission directionality set, based on the communication parameter set, to perform the communication with first external device 200A.

Next, wireless communicating apparatus 100 allows wireless communicating device 140 to transmit a radiowave (response signal (SSWFB in FIG. 4)) including the sector ID selected as the best sector ID (arrow S12 illustrated in FIG. 4).

In the following, a case will be described in which the best sector ID included in the response signal from wireless communicating apparatus 100 is sector ID1.

At this time, the best sector ID of first external device 200A is known. Therefore, controller 150 refers to memory 160 to set the communication parameter corresponding to the best sector ID of first external device 200A to wireless communicating device 140 as the transmission directionality selected. In the above example, the communication parameter associated with sector ID3 is set to wireless communicating device 140.

Then, wireless communicating apparatus 100, based on the setting, performs subsequent communication with first external device 200A. Specifically, the service described in detail below is mutually executed, such as data transmission (Transmit Data) illustrated in FIG. 4.

As described above, by the communication attempt for selecting the transmission directionality of wireless communicating apparatus 100, it is possible to estimate in a short time a direction of external device 200 such as first external device 200A.

In the above, with reference to FIG. 4, an example has been described in which external device 200 cannot control the transmission directionality, and the communication attempt is performed in one sector; however the example is not limited thereto. For example, in a case of external device 200 including a configuration capable of controlling the transmission directionality, the communication attempt of sector sweeping may be performed to wireless communicating apparatus 100 from external device 200. That is, the communication attempt may be executed bi-directionally between wireless communicating apparatus 100 and external device 200.

In this case, when transmitting the response signal to wireless communicating apparatus 100, external device 200 performs the communication attempt as follows.

Specifically, controller 250 of first external device 200A performs the communication attempt of sector sweeping in which the response signal is transmitted while switching the transmission directionalities configured by the sector, in a state of including the best sector ID as a response.

Then, wireless communicating apparatus 100 receives the radiowave of the response signal in the communication attempt from first external device 200A. Therefore, wireless communicating apparatus 100 performs a response that returns the best sector ID to the communication attempt, to first external device 200A. At this time, controller 150 of wireless communicating apparatus 100, which is the same as controller 250 of first external device 200A, measures reception quality (for example, SNR or BER) of a signal to be obtained from the radiowave of the response signal received by wireless communicating device 140. Then, normally, controller 150 selects the sector ID of the response signal of the most satisfactory reception quality as the best sector ID.

At this time, the best sector ID of wireless communicating apparatus 100 is known. Therefore, controller 250 refers to memory 260 to set the communication parameter corresponding to the best sector ID of wireless communicating apparatus 100 to wireless communicating device 240 as the transmission directionality selected.

Then, first external device 200A, based on the setting, performs subsequent communication with wireless communicating apparatus 100. Specifically, the service described in detail below is mutually executed, such as file transfer with data transmission illustrated in FIG. 4.

As described above, the communication attempt is performed bi-directionally between wireless communicating apparatus 100 and first external device 200A. Thus, directions of wireless communicating apparatus 100 and first external device 200A are mutually estimated, and a predetermined service can be executed in an optimal state.

### <Operation of Wireless Communicating Apparatus>

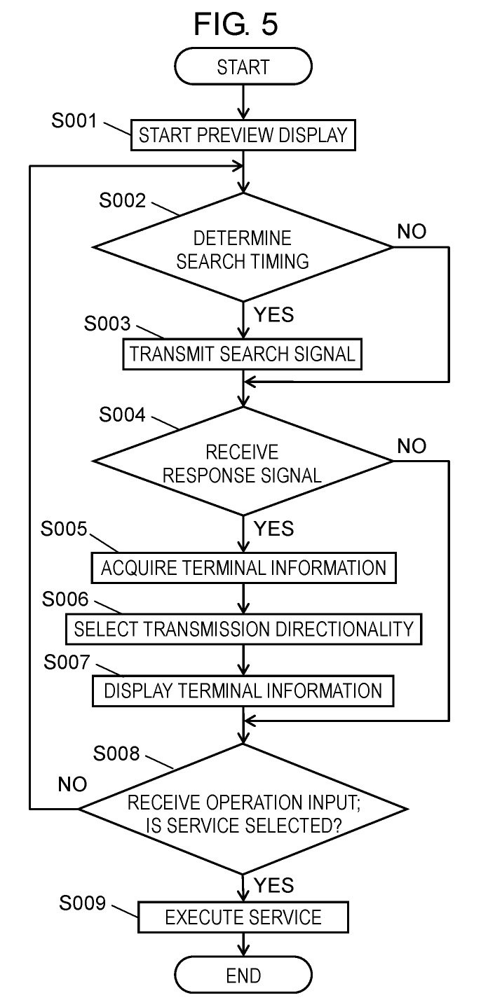

Next, an operation of wireless communicating apparatus 100 will be described with reference to FIG. 5.

FIG. 5 is a flowchart illustrating one example of operation of the wireless communicating apparatus according to the first exemplary embodiment.

As illustrated in FIG. 5, controller 150 of wireless communicating apparatus 100 first receives an operation for imaging by the user via input device 130. Then, controller 150, via image pick-up sensor 110, starts imaging of a periphery of wireless communicating apparatus 100. Upon starting of imaging, controller 150 switches display 120 to a preview screen, and displays a preview of a taken image (Step S001). The preview display of the taken image is continuously performed in the following steps.

Next, controller 150 determines search timing for searching external device 200 (Step S002). The search timing is timing for executing beam forming including a plurality of transmission directionalities. In the present disclosure, controller 150 executes searching at a period of the beacon signal, for example. Specifically, controller 150 determines whether or not a BTI (Beacon Transmission Interval) of a beacon interval arrives. Then, when the BTI arrives, controller 150 determines that it is the search timing.

That is, when the search timing arrives (YES in Step S002), controller 150 starts transmission of the search signal while switching the plurality of transmission directionalities via wireless communicating device 140 (Step S003). That is, controller 150 performs transmission of the search signal of the above beam forming. In this case, controller 150 refers to memory 160 to sequentially select the sector ID. Controller 150, for each selection of the sector ID, sets the communication parameter corresponding to the sector ID to wireless communicating device 140. Then, controller 150 transmits the radiowave of the search signal toward an area in a predetermined communication range while switching the transmission directionalities. Specifically, wireless communicating device 140, when an area of the transmission directionality to which the search signal can be transmitted is divided into n pieces of sectors, sequentially switches the n pieces of sectors to perform n times of transmission of the search signal.

The predetermined communication range is, for example, at least an imaging range of image pick-up sensor 110. In addition, the predetermined communication range is a display range of display 120 to be described later.

Next, controller 150 determines whether or not the response signal is received from external device 200 to each search signal transmitted while switching the transmission directionalities (Step S004). At this time, when the response signal is not received (NO in Step S004), controller 150 proceeds to Step S008 to execute a subsequent step.

On the other hand, when the response signal is received (YES in Step S004), controller 150 acquires the terminal information of external device 200 from the response signal. Further, controller 150 acquires the best sector ID from the response signal (Step S005).

Next, controller 150, based on the best sector ID acquired, estimates the direction of external device 200. Then, controller 150 estimates the sector, that is, a range of the transmission directionality in which external device 200 exists (Step S006).

At this time, controller 150, when there is the plurality of external devices 200, executes processing of Step S005 and Step S006 to all response signals received from external devices 200 in, for example, a predetermined time (transmission period of beacon signal). That is, controller 150, where switching operation of the plurality of transmission directionalities is one set, searches the plurality of external devices 200 by the search signal of the one set. Thus, controller 150 acquires the best sector ID from the response signal from the plurality of external devices 200, and estimates the directions of the plurality of external devices 200.

A case will be described below in which first external device 200A and second external device 200B exist in a communication range of wireless communicating device 140 that is configured by a transmission directionality of n pieces of sectors, for example.

Wireless communicating apparatus 100, first, receives the response signal to the search signal from both of first external device 200A and second external device 200B. Controller 150, based on the response signal from first external device 200A, performs acquisition of the terminal information and estimation of the direction of first external device 200A. Similarly, controller 150, based on the response signal from second external device 200B, performs acquisition of the terminal information and estimation of the direction of second external device 200B.

Then, controller 150, after acquiring the best sector ID of each of first external device 200A and second external device 200B, completes the beam forming as wireless communicating apparatus 100.

As described above, when external device 200 includes the configuration capable of controlling the transmission directionality, external device 200 executes transmission of the response signal as part of the communication attempt. Therefore, although it is omitted in FIG. 5, controller 150, when receiving the response signal from external device 200, measures the reception quality during the communication attempt of external device 200. Controller 150, based on the measurement result, selects the best sector ID in which the reception quality is the best. Then, controller 150 executes processing for transmitting the response signal (corresponding to SSWFB in FIG. 4) including the best sector ID selected to external device 200.

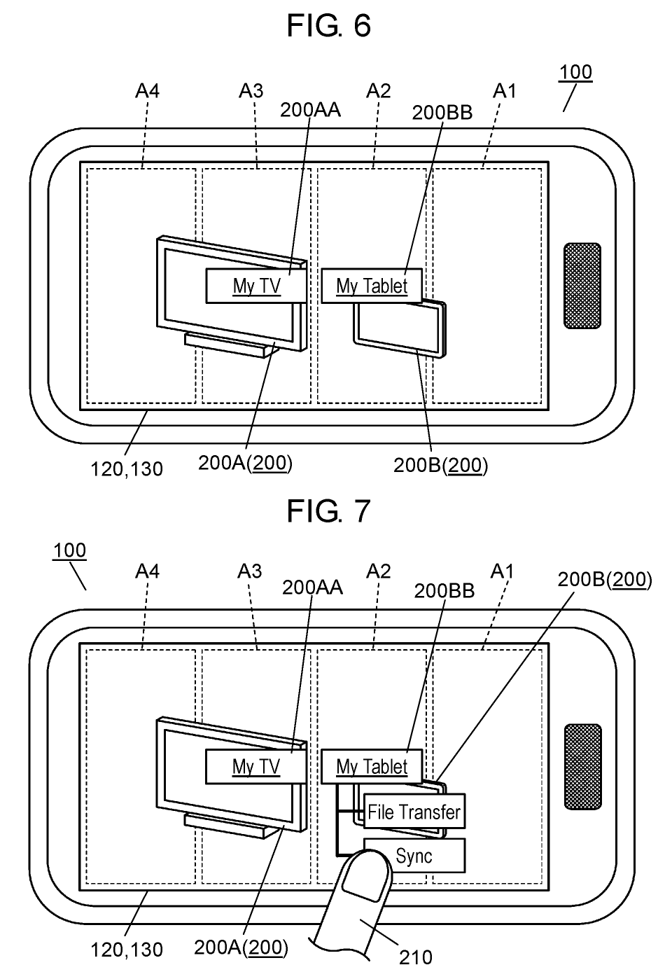

Next, as illustrated in FIG. 5, controller 150 displays the terminal information that is information about external device 200 by being superimposed on external device 200 of the taken image of display 120, as illustrated in FIG. 6, for example (Step S007).

At this time, display 120 of wireless communicating apparatus 100 is divided into several display areas depending on a number of sectors divided (corresponding to respective transmission directionalities). For example, when a radiowave transmission area of wireless communicating device 140 has the transmission directionality divided into four sectors in the horizontal direction, display 120 is also divided into four display areas (first area A1 to fourth area A4) in the horizontal direction (see FIG. 6).

Then, controller 150 displays the terminal information of external device 200 in a display area of display 120 corresponding to the sector in which external device 200 is estimated to exist, in the direction of the transmission directionality selected. In this case, an exact position of external device 200 in the corresponding display area may not be estimated. However, the terminal information is displayed in the display area that displays external device 200, so that the terminal information is displayed generally near external device 200. The terminal information is a user interface for the user to identify or operate external device 200 displayed on display 120.

Then, controller 150, for all external devices 200 that receive the response signal, displays the terminal information in a predetermined display area of display 120 similarly to the above. The above operation is executed while all of the sectors divided are swept at one time. Thus, search time can be reduced for searching the plurality of external devices 200.

A specific display example to be displayed on display 120 will be described below with reference to FIG. 6.

FIG. 6 is a diagram illustrating a display example of a display according to the first exemplary embodiment.

In the display example illustrated in FIG. 6, first external device 200A is positioned at third sector S3 in an area of the plurality of transmission directionalities, and second external device 200B is positioned at second sector S2. Therefore, on display 120, the most part of first external device 200A is displayed in third area A3 of display 120 of wireless communicating apparatus 100 corresponding to third sector S3. Similarly, the most part of second external device 200B is displayed in second area A2 of display 120 corresponding to second sector S2. Further, in third area A3 of display 120, as terminal information 200AA of first external device 200A, an identification name of first external device 200A such as “My TV” is displayed. Similarly, in second area A2 of display 120, as terminal information 200BB of second external device 200B, an identification name of second external device 200B such as “My Tablet” is displayed. In this case, as the terminal information of external device 200, a MAC address and the like may be displayed. Thus, even when the plurality of external devices 200 of the same type exists in different display areas, they can be easily identified and can be operated. In addition, even when the plurality of external devices 200 is displayed in the same display area, as the terminal information, only the terminal information is displayed of external devices 200 in which the reception quality is the best among the plurality of external devices 200.

Here, terminal information 200AA, 200BB are normally disposed in a substantially center (including a center) of the corresponding display area. In display 120 illustrated in FIG. 6, although positions of terminal information 200AA, 200BB corresponding to respective external devices 200 are displayed with more or less displacement, the terminal information is displayed on corresponding external devices 200.

Next, as illustrated in FIG. 5, controller 150 determines whether or not service selection operation is performed via input device 130 by the user (Step S008).

The service selection operation of Step S008 will be described in detail below.

First, controller 150 acquires the best sector ID of external device 200 by the communication attempt to establish communication with external device 200. After that, controller 150 acquires service information via the communication from external device 200. The service information is information indicating association between the service that can be executed by external device 200 and a communication protocol to be used when the service is executed, and is stored in advance in external device 200. For example, when external device 200 can execute file transfer with a TCP/IP protocol, external device 200 stores the service information that associates the file transfer and the TCP/IP protocol with each other. The association included in the service information may be one or more. For example, in external device 200 preparing a plurality of services, when one of the services can be selected and executed, the service information is stored including a plurality of combinations of the service and the corresponding communication protocol. In external device 200 preparing a plurality of communication protocols to one service, when one of the communication protocols can be selected and executed, the service information is stored including a number of different communication protocols in combinations of the one service and the corresponding communication protocol.

Then, controller 150, based on the service information acquired, creates a service selection menu. The service selection menu is displayed in the preview screen of display 120 when, for example, the user performs predetermined operation.

The service selection menu displays the service that can be executed between external device 200 and wireless communicating apparatus 100 as one example of the terminal information of external device 200. That is, the service selection menu functions as a user interface for allowing the user to select a desired service from the service selection menu.

The service selection menu does not necessarily need to display all of the services included in the service information. For example, when the service that cannot be executed by wireless communicating apparatus 100 is included in the service information, the service that cannot be executed may not be displayed as the service selection menu.

Normally, the service selection menu is not displayed on display 120. To display the service selection menu, the user taps the corresponding terminal information illustrated in FIG. 6 by a finger or the like. Thus, controller 150 displays the service selection menu in a form of a pull-down menu on display 120. In an example illustrated in FIG. 7, file transfer (File transfer) and data synchronization (Sync) are displayed as the pull-down menu in the service selection menu. File transfer is a service of performing file transfer between wireless communicating apparatus 100 and external device 200. Data synchronization is a service of performing synchronization of data shared between wireless communicating apparatus 100 and external device 200. For example, at least one of the TCP/IP protocol, the SD protocol, and the USB (Universal Serial Bus) protocol is associated with file transfer. The SD protocol and the USB protocol are PAL (Protocol Adaptation Layer) protocol in which a wired bus protocol is adapted for an MAC (Media Access Controller) layer.

The service selection menu, instead of the pull-down menu, may always be displayed on display 120 with the terminal information.

In addition, when a plurality of communication protocols is associated with one service, controller 150 displays the plurality of communication protocols in the service selection menu. It may be configured to allow the user to select a desired communication protocol via the service selection menu.

Then, when the user selects the service (for example, data synchronization) by tapping (see FIG. 7) with finger 210 or the like from the service selection menu displayed, controller 150 receives the service selection operation.

With the above, the service selection operation of Step S008 is executed.

At this time, when the service is selected by the user (YES in Step S008), controller 150 executes the service selected (Step S009). In this case, the communication protocol used for executing the service is the communication protocol associated with the service.

During from execution start to end of the service, controller 150 may display a message notifying that the service is being executed or a progress bar indicating a status of the service being executed in the preview screen. By such a display, it is possible to urge the user to refrain to move of wireless communicating apparatus 100, and thus it is possible to prevent disconnection of wireless communication with external device 200.

Then, when the service execution ends, controller 150 terminates the flow.

On the other hand, when there is no service selection operation (NO in Step S008), controller 150 returns to Step S002. Incidentally, determination of presence or absence of the service selection operation (Step S008) can be performed only during a predetermined waiting time. That is, when there is no service selection operation after the predetermined waiting time, controller 150 may control the flow to return to Step S002. Thus, unnecessary waiting time can be reduced.

Further, after returning to Step S002, controller 150 repeatedly executes processing of Step S002 and subsequent steps.

As described above, operation of wireless communicating apparatus 100 is executed.

Operation of external device 200 will be described below.

First, in external device 200, controller 250, when receiving the search signal from wireless communicating apparatus 100, measures the reception quality during the communication attempt of wireless communicating apparatus 100. Then, controller 250, based on the measurement result, selects the best sector ID in which the reception quality is the best.

Next, controller 250 transmits a response signal including the best sector ID selected to wireless communicating apparatus 100.

When external device 200 includes the configuration capable of controlling the transmission directionality, external device 200 executes transmission of the response signal as part of the communication attempt. That is, controller 250, similarly to Step S003 illustrated in FIG. 5, including the best sector ID, transmits the search signal for searching the direction of wireless communicating apparatus 100 from external device 200 as the response signal.

Next, controller 250, similarly to Step S004 illustrated in FIG. 5, determines whether or not the response signal to the search signal is received from wireless communicating apparatus 100. When the response signal is received (YES in Step S004), similarly to Step S006 of FIG. 5, controller 250 acquires the best sector ID from the response signal. Then, controller 250 sets the communication parameter corresponding to the best sector ID to wireless communicating device 240. Thus, controller 250 performs subsequent execution of the service and the like with wireless communicating apparatus 100 with the communication parameter set.

Next, external device 200 determines whether or not there is an execution command of the service from wireless communicating apparatus 100. When receiving the execution command of the service, external device 200 executes the corresponding service with wireless communicating apparatus 100.

As described above, operation of external devices 200 is executed.

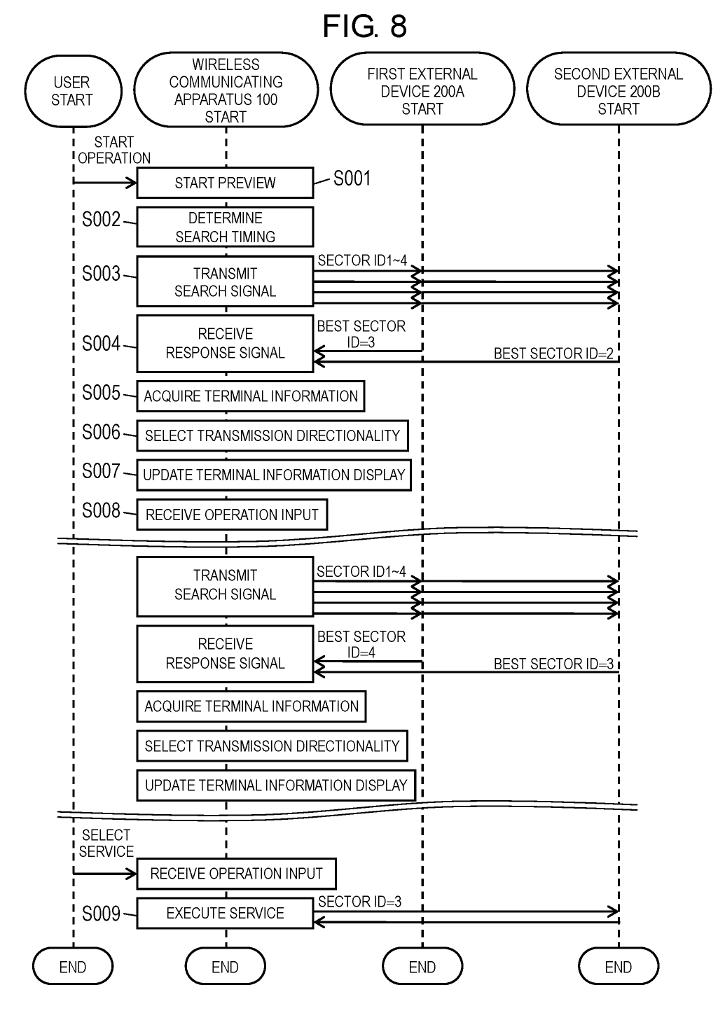

Operation between wireless communicating apparatus 100 and external device 200 will be described below with reference to FIG. 8.

FIG. 8 is a sequence diagram of operation between the wireless communicating apparatus and the external device according to the first exemplary embodiment.

A part of each of steps in wireless communicating apparatus 100 illustrated in FIG. 8 corresponds to each of the steps of the flowchart described in FIG. 5.

In the following, a case will be described in which first external device 200A and second external device 200B exist in the communication range of wireless communicating device 140 (range of all transmission directionalities).

As illustrated in FIG. 8, first, the user inputs imaging operation via input device 130 of wireless communicating apparatus 100. Wireless communicating apparatus 100 receives the imaging operation, and starts imaging via image pick-up sensor 110. Then, wireless communicating apparatus 100 switches display 120 to the preview screen to preview the taken image (Step S001).

Next, wireless communicating apparatus 100 performs determination by monitoring the search timing at the cycle of the beacon signal (Step S002). When determining arrival of the search timing, wireless communicating apparatus 100 performs transmission of the search signal (Step S003). Specifically, controller 150 sequentially sets the communication parameters respectively corresponding to sector ID1 to sector ID4 defining the transmission directionalities to wireless communicating device 140. Then, controller 150 transmits the search signal while switching the transmission directionalities. Thus, search signals respectively corresponding to sector ID1 to sector ID4 are sequentially transmitted in the communication range divided.

Next, first external device 200A and second external device 200B measures the reception quality of a signal to be obtained from a radiowave of the search signal received to decide the best sector ID. Then, first external device 200A and second external device 200B each transmit a response signal including the best sector ID decided to wireless communicating apparatus 100. In the example illustrated in FIG. 8, the best sector ID of first external device 200A is sector ID3, and the best sector ID of second external device 200B is sector ID2.

Next, wireless communicating apparatus 100 receives each response signal from first external device 200A and second external device 200B (Step S004). Wireless communicating apparatus 100 acquires the terminal information of each of external devices 200 from each response signal (Step S005), and acquires the best sector ID.

Next, wireless communicating apparatus 100 obtains directions of first external device 200A and second external device 200B from the best sector ID. Then, wireless communicating apparatus 100 selects the transmission directionalities suitable for the directions of first external device 200A and second external device 200B (sector ID in transmission) (Step S006). At this time, wireless communicating apparatus 100 stores the sector ID selected in memory 160 with the terminal information.

Next, wireless communicating apparatus 100 displays the terminal information corresponding to first external device 200A and second external device 200B near or superimposing on the taken image on display 120 (Step S007). At this time, each of pieces of the terminal information is displayed in the display area of display 120 corresponding to the sector in which each of external devices 200 exists. Thus, wireless communicating apparatus 100 becomes an input reception state of the service selection operation by the user.

Then, when there is no service selection operation from the user, wireless communicating apparatus 100 returns to Step S002 to redo from determination of the search timing. That is, wireless communicating apparatus 100 repeats the above processing until the service selection operation is input from the user.

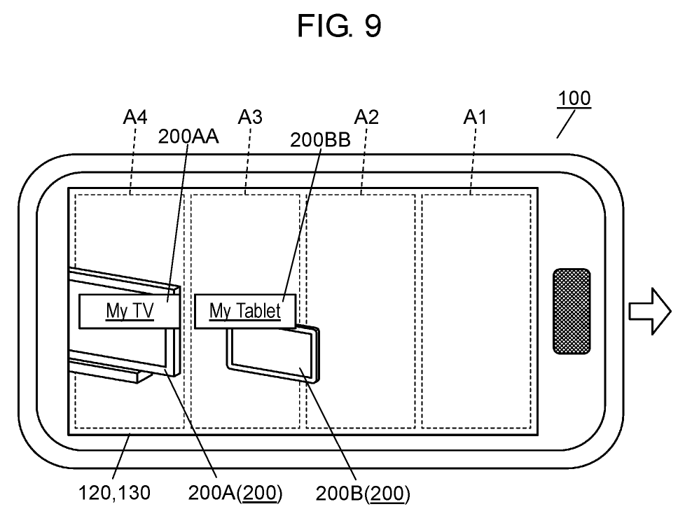

At this time, in the above state, when there is a movement of wireless communicating apparatus 100, change of an attitude of wireless communicating apparatus 100, or a movement of external device 200, the sector is changed which is the direction of the transmission directionality in which external device 200 exists. For example, when wireless communicating apparatus 100 moves to the right from the state of FIG. 6 to be the state illustrated in FIG. 9, first external device 200A and second external device 200B move to the left on display 120. Specifically, the display position of first external device 200A is changed to the display area of fourth area A4 from third area A3. Similarly, the display position of second external device 200B is changed to the display area of third area A3 from second area A2.

Here, normally, controller 150 executes the beam forming for each search timing synchronized with the period of the beacon signal (for example, about 100 ms). Then, for each search timing, controller 150 always estimates the directions of first external device 200A and second external device 200B based on the response signal returned. Therefore, in the beam forming of after the movement of wireless communicating apparatus 100, the best sector ID is changed that is included in the response signal returned from external device 200. Specifically, the best sector ID returned with the response signal by first external device 200A is sector ID4. Similarly, the best sector ID returned with the response signal by second external device 200B is sector ID3.

Controller 150, based on these response signals, updates the display area to which the terminal information is displayed on display 120. Specifically, controller 150 displays the terminal information of first external device 200A in fourth area A4 corresponding to fourth sector S4. Similarly, controller 150 displays the terminal information of second external device 200B in third area A3 corresponding to third sector S3.

In the example of the present disclosure, the search timing is the beacon signal. Therefore, controller 150, synchronizing with the beacon signal, repeats estimation of the direction of external device 200 periodically. Then, depending on the direction of external device 200 to be estimated, controller 150 updates display positions of the service selection menu and the terminal information of external device 200 of display 120. Thus, even when the position of external device 200 displayed on display 120 is changed due to the movement of wireless communicating apparatus 100 or external device 200, controller 150 updates the display position of the service selection menu and the terminal information. As a result, it is possible to allow the terminal information and the service selection menu to follow the movement of external device 200 and to be displayed.

That is, while wireless communicating apparatus 100 periodically estimates the position of external device 200 and updates the display position of the service selection menu and the terminal information, the user can perform the service selection operation.

Then, wireless communicating apparatus 100 receives the service selection operation of the user, and executes the service selected with corresponding external device 200 (Step S009). For example, when the service selected by the user is data transmission from second external device 200B, wireless communicating apparatus 100 allows second external device 200B to transmit the data. At this time, to wireless communicating device 140 of wireless communicating apparatus 100, the communication parameter is set corresponding to sector ID3 that defines the transmission directionality selected. On the other hand, to wireless communicating device 240 of second external device 200B, the communication parameter is set corresponding to the best sector ID obtained by the latest communication attempt from wireless communicating apparatus 100. Thus, wireless communicating apparatus 100 and second external device 200B, based on the best sector ID that is the direction of the transmission directionality selected, can execute a predetermined service.

As described above, the present exemplary embodiment is wireless communicating apparatus 100 that performs wireless communication with an external device, and includes: a wireless communicating device having a plurality of transmission directionalities and capable of switching the transmission directionalities; display 120 having a plurality of display areas corresponding to the respective transmission directionalities and displaying information about the external device; and controller 150 that controls wireless communicating device 140 and display 120. Controller 150 is configured to allow the wireless communicating device to transmit the search signal by switching the transmission directionalities and to select the transmission directionality based on a response signal received from the external device, and the display to display the information about the external device in a display area corresponding to the transmission directionality selected.

With this configuration, wireless communicating apparatus 100 transmits the search signal in a communication range while sequentially switching the plurality of transmission directionalities. Wireless communicating apparatus 100, based on the response signal from external device 200 to the search signal transmitted, selects the direction of the transmission directionality to estimate the direction of external device 200. Then, wireless communicating apparatus 100 displays information such as external device 200 and its terminal information, for example, by being superimposed in the predetermined display area of display 120 corresponding to the direction of the transmission directionality selected. Thus, the user can intuitively recognize external device 200 that perform wireless communication and its terminal information. At this time, even when the display area displaying external device 200 on display 120 is moved due to the movement of wireless communicating apparatus 100 or external device 200, wireless communicating apparatus 100, based on the response signal from external device 200 to the search signal transmitted by switching the transmission directionality, again periodically selects the direction of the transmission directionality. Thus, it is possible to allow the terminal information to follow a motion of external device 200, and to move the terminal information to the predetermined display area to be displayed. As a result, even when wireless communicating apparatus 100 or external device 200 is moved, the service and the like can be more appropriately executed with communication via the terminal information displayed on display 120.

In more detail, wireless communicating apparatus 100, while switching the plurality of transmission directionalities, transmits the search signal to external device 200 in the communication range. External device 200 returns the response signal including the information about the reception quality of the search signal to wireless communicating apparatus 100. Thus, wireless communicating apparatus 100 can detect the direction in which the search signal is transmitted to increase the reception quality of external device 200. That is, wireless communicating apparatus 100 can estimate the direction of external device 200 based on the reception quality.

At this time, wireless communicating apparatus 100 does not individually execute transmission of the search signal to be transmitted while switching the transmission directionalities to each of the plurality of external devices 200. That is, wireless communicating apparatus 100 executes the transmission of the search signal while switching the transmission directionalities in one set to an entire of one or more external devices 200 in the communication range. Specifically, each of the plurality of external devices 200 receives the search signal transmitted once in a certain transmission directionality. In addition, each of the plurality of external devices 200 receives the search signal transmitted once in the other transmission directionality different from the above.

Therefore, in comparison with a conventional case in which the search signal is individually transmitted to each of the external devices by switching the transmission directionalities, it is possible to shorten time to receive the response signal from the plurality of external devices. Thus, it is possible to estimate the directions of the plurality of external devices in a short time. Then, it is also possible to estimate the display area of each of external devices 200 on display 120 in a short time. As a result, it is possible to allow the terminal information to follow the movement of each of external devices 200 and to be displayed in the display area on display 120.

In addition, wireless communicating apparatus 100 of the present exemplary embodiment is configured so that a direction in which the search signal is transmitted by switching the plurality of transmission directionalities and a direction in which the plurality of display areas are lined coincide with each other.

Thus, the user can intuitively recognize the direction of external device 200 that performs wireless communication. As a result, it is possible to prevent an operation error and a selection error of external device 200 of the user.

In wireless communicating apparatus 100 of the present exemplary embodiment, the response signal includes information about the reception quality to the search signal, and the controller selects the transmission directionality corresponding to the search signal in which the reception quality is the best.

With this configuration, wireless communicating device 140 of wireless communicating apparatus 100 receives the response signal in which the reception quality is the best from external device 200. Then, controller 150 selects the transmission directionality of the search signal corresponding to the response signal in which the reception quality is the best, as the direction of external device 200. Thus, wireless communicating apparatus 100 can communicate with external device 200 at high reception quality.

In addition, controller 150 of the present exemplary embodiment periodically performs a set of switching operation of the plural transmission directionalities, and updates display of display 120.

With this configuration, controller 150, where the switching operation of the plurality of transmission directionalities is one set, synchronizes the one set of operation with the beacon signal to periodically execute the operation. Thus, even when wireless communicating apparatus 100 or external device 200 relatively moves, the direction of external device 200 can periodically be detected. As a result, it is possible to allow the terminal information to follow the movement of the display position of external device 200 on display 120 and to be displayed.

More specifically, controller 150 synchronizes the one set of the switching operation of the plural transmission directionalities with the beacon signal to transmit the search signal, and executes the communication attempt. Thus, even when wireless communicating apparatus 100 or external device 200 relatively moves, it is possible to estimate the display area of external device 200 on display 120. As a result, in the display area estimated, it is possible to update and display the display position of the terminal information and the like in display 120.

In this case, the beacon signal, as described above, is transmitted in a short period of about 100 ms. Therefore, update of the display area of external device 200 on display 120 is also executed in the short period. Thus, it is possible to allow the terminal information on display 120 to follow the movement of external device 200 and to be displayed.

Further, the beacon signal is a signal for establishing wireless communication between wireless communicating apparatus 100 and external device 200. Therefore, when the communication attempt is performed, it is possible to easily synchronize wireless communicating apparatus 100 and external device 200 with each other based on the beacon signal.

In addition, wireless communicating apparatus 100 of the present exemplary embodiment further includes an image pick-up sensor that acquires an image, and an imaging area of the image pick-up sensor is included in a communication range that the plurality of transmission directionalities has.

With this configuration, the communication range of the plurality of transmission directionalities to be transmitted from wireless communicating apparatus 100 covers the imaging area to be taken by the image pick-up sensor such as a camera. Thus, to external device 200 to be imaged, it is possible to reliably transmit the search signal to be transmitted to the directions of the plurality of transmission directionalities. As a result, to external device 200 imaged, it is possible to display the terminal information of external device 200 in an appropriate display area of display 120 based on the response signal from external device 200.

In the above exemplary embodiment, although wireless communicating apparatus 100 is described as the PCP/AP, wireless communicating apparatus 100 is not limited the example. For example, wireless communicating apparatus 100 can function as an STA. In this case, wireless communicating apparatus 100 transmits a probe request in a predetermined period as the search signal. Then, wireless communicating apparatus 100 receives a probe response from external device 200 as the response signal. Thus, it is possible to estimate the direction of external device 200.

### Second Exemplary Embodiment

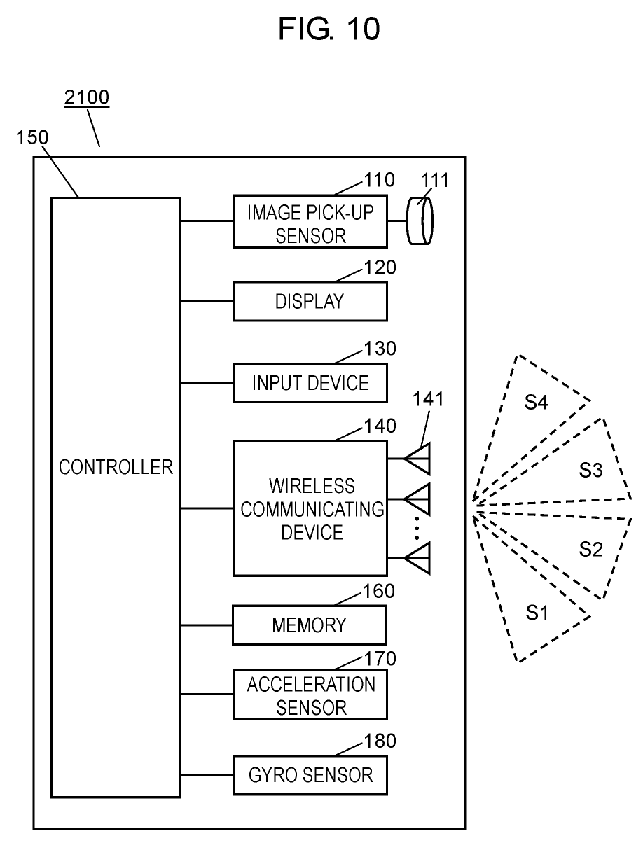

A wireless communicating apparatus according to a second exemplary embodiment will be described below with reference to FIG. 10.

Wireless communicating apparatus 2100 of the present exemplary embodiment is different from wireless communicating apparatus 100 of the first exemplary embodiment in that wireless communicating apparatus 2100, when there is a movement of external device 200 on display 120, estimates a direction of external device 200 from wireless communicating apparatus 2100 by a communication attempt, and updates display of terminal information of display 120.

Therefore, in the following, a different part from wireless communicating apparatus 100 will be mainly described in a configuration of wireless communicating apparatus 2100. For the same configuration as wireless communicating apparatus 100, it is denoted by the same reference numeral, and description thereof is omitted.

Also in the present exemplary embodiment, similarly to the first exemplary embodiment, an information processing device is described as wireless communicating apparatus 100, such as a mobile phone having an image pick-up sensor such as a camera.

FIG. 10 is a block diagram of the wireless communicating apparatus according to the second exemplary embodiment.

Wireless communicating apparatus 2100 configures an information processing device capable of wireless communication with external device 200.

Specifically, wireless communicating apparatus 2100, as illustrated in FIG. 10, includes image pick-up sensor 110, display 120, input device 130, wireless communicating device 140, controller 150, memory 160, and sensors such as acceleration sensor 170 and gyro sensor 180. Each of acceleration sensor 170 and gyro sensor 180 is one example of the sensor that detects motion of wireless communicating apparatus 2100.

Acceleration sensor 170 detects acceleration of wireless communicating apparatus 2100. Based on a result of the detection by acceleration sensor 170, it is possible to detect the movement of wireless communicating apparatus 2100.

Gyro sensor 180 detects a change in an attitude of wireless communicating apparatus 2100. Other than gyro sensor 180, it is possible to employ a direction sensor to detect the change in the attitude of wireless communicating apparatus 2100.

Wireless communicating apparatus 2100 performs highly directional wireless communication in millimeter wave communication using, for example, a 60 GHz band. Wireless communicating apparatus 2100 performs the communication attempt with external devices 200 by beam forming of sector sweeping.

In addition, wireless communicating apparatus 2100, similarly to wireless communicating apparatus 100, operates according to the flowchart illustrated in FIG. 5; however, search timing is different from the search timing of wireless communicating apparatus 100.

That is, controller 150, as illustrated in Step S002 of FIG. 5, determines that it is the search timing when wireless communicating apparatus 2100 is moved or when the attitude of wireless communicating apparatus 2100 is changed.

Specifically, controller 150, based on the detection result of acceleration sensor 170, monitors the movement of wireless communicating apparatus 2100. When acceleration sensor 170 detects the movement of wireless communicating apparatus 2100, controller 150 determines that it is the search timing.

In addition, controller 150, based on the detection result of gyro sensor 180, monitors the change in the attitude of wireless communicating apparatus 2100. When gyro sensor 180 detects the change in the attitude of wireless communicating apparatus 2100, controller 150 determines that it is the search timing.

Further, controller 150 may monitor a motion of an object of a taken image and, when there is the motion of the object, determine that, for example, the attitude of wireless communicating apparatus 2100 is changed, and determine that it is the search timing. In this case, controller 150 performs image processing of the taken image to monitor the motion of the object. As the image processing, well-known image processing can be used. In the example of the present disclosure, controller 150, when there is a motion of any object in the taken image, determines that it is the search timing. The motion of the object, other than the above, for example, includes a motion of a moving object such as a drone, and a motion of a person holding external device 200.

Controller 150 may extract a feature point from the taken image and, when there is a motion of the feature point, determine that it is the search timing.

In addition, controller 150 may perform image recognition of a shape of external device 200 or a marker attached to external device 200 to identify external device 200 from the taken image. In this case, controller 150, when there is a motion of external device 200 in the taken image, determines that it is the search timing.

By the above method, when the search timing arrives, controller 150 starts transmission of a search signal to directions of a plurality of transmission directionalities divided as illustrated in Step S003 of FIG. 5. However, controller 150, when the search timing arrives, may transmit the search signal independently of a period of a beacon signal. Further, controller 150 may transmit the search signal at a period of the beacon signal immediately after the search timing arrives.

Since Step S003 and subsequent processing illustrated in FIG. 5 are the same as the processing of wireless communicating apparatus 100, description thereof is omitted.

As described above, wireless communicating apparatus 2100 of the present exemplary embodiment further includes acceleration sensor 170 and gyro sensor 180 that detect the motion of wireless communicating apparatus 2100. Thus, wireless communication apparatus 2100 detects motions such as the movement and change in the attitude of wireless communicating apparatus 2100.

Controller 150, when acceleration sensor 170 or gyro sensor 180 detects the motion of wireless communicating apparatus 2100, determines that it is the search timing, and executes the communication attempt. Then, based on the response signal from external device 200 to the search signal of predetermined transmission directionality, controller 150 estimates a display area of external device 200 on display 120. Then, controller 150 updates display to display the terminal information of external device 200 in the display area estimated. Thus, even when wireless communicating apparatus 2100 is moved, it is possible to appropriately display the terminal information in the display area in which external device 200 exists.

Further, as described above, controller 150, when detecting the motion of the object based on the taken image of image pick⁻up sensor 110, executes the communication attempt. Then, controller 150 estimates the display area of external device 200 on display 120, and updates the display of the terminal information on display 120.

With this configuration, when there is the motion of wireless communicating apparatus 2100, wireless communicating apparatus 2100 determines that it is the search timing, and switches the plurality of transmission directionalities to transmit the search signal. Based on the response signal from external device 200 to the search signal transmitted, wireless communicating apparatus 2100 selects a particular transmission directionality. Then, wireless communicating apparatus 2100 updates the display of the terminal information of external device 200 in the display area of display 120 corresponding to the transmission directionality selected.

That is, when there is a motion such as the movement and the change in the attitude of wireless communicating apparatus 2100, the display area may be changed of external device 200 on display 120 of wireless communicating apparatus 2100. Therefore, in the present exemplary embodiment, when there is the motion of wireless communicating apparatus 2100, wireless communicating apparatus 2100 estimates the direction of external device 200 by the communication attempt. Based on the estimation, wireless communicating apparatus 2100 estimates the display area of external device 200 on display 120. Then, wireless communicating apparatus 2100 updates the display of the terminal information on display 120 in the display area estimated. As a result, even when wireless communicating apparatus 2100 is moved, it is possible to allow the terminal information to follow the movement of external device 200 and to be displayed.

Similarly, as described above, when there is the motion of the object, wireless communicating apparatus 2100 updates the display of the terminal information of external device 200 on display 120.

That is, when there is the motion of the object in the taken image, the display area may be changed of external device 200 on display 120. Therefore, in the present exemplary embodiment, when there is the motion of the object, wireless communicating apparatus 2100 estimates the direction of external device 200 by the communication attempt. Based on this, wireless communicating apparatus 2100 estimates the display area of external device 200 on display 120. Then, wireless communicating apparatus 2100 updates the display of the terminal information in display 120 to the display area estimated. As a result, it is possible to allow the terminal information to follow the movement of external device 200 and to be displayed.

In the above exemplary embodiment, although the configuration including acceleration sensor 170 and gyro sensor 180 is described as the example, wireless communicating apparatus 2100 can be configured with only any one of the sensors. Further, any sensor may be used other than acceleration sensor 170 and gyro sensor 180, as far as the sensor can detect the motion of wireless communicating apparatus 2100.

In the above exemplary embodiment, wireless communicating apparatus 2100 detects the motion of itself with acceleration sensor 170 and gyro sensor 180. Further, wireless communicating apparatus 2100 detects the motion of the object of the taken image by image recognition. Although the configuration is described as the example in which it is determined that the search timing arrives when one of the motions is detected of wireless communicating apparatus 2100 itself and the object, the configuration is not limited to this example. For example, wireless communicating apparatus 2100 can be configured to detect the motion of wireless communicating apparatus 2100 itself or the motion of the object of the taken image to determine that the search timing arrives when the corresponding motion is detected.

### Other Exemplary Embodiment

As described above, the exemplary embodiments have been described as examples of the technique disclosed in the present application.

However, the technique in the present disclosure is not limited to the example, and it is also possible to apply to an exemplary embodiment in which modification, replacement, addition, omission are appropriately performed.

In addition, it is also possible to make a new exemplary embodiment by combining elements described in the above exemplary embodiments.

Therefore, other exemplary embodiment will be described as an example below.

For example, in the present exemplary embodiment, wireless communicating apparatus 100 may be a tablet, a PC, a television, an e-book reader, a music player, a gaming machine, or the like. Similarly, external device 200 is not limited to a television and a tablet, and may be a PC, a digital camera, a smartphone, a music player, a gaming machine, or the like.

In the present exemplary embodiment, each component such as controller 150, controller 250 can be configured by dedicated hardware. It can be configured to be implemented by executing software suitable for each component. Further, each of the components may be configured such that a program executor such as a CPU or a processor reads and executes a software program stored in a storage medium such as a hard disk or a semiconductor memory.

Further, a comprehensive or specific aspect of the present disclosure may be a configuration realized by a system, a method, an integrated circuit, a computer program, or a storage medium such as a computer-readable CD-ROM.

Moreover, a comprehensive or specific aspect of the present disclosure may be a configuration realized by any combination of a system, a method, an integrated circuit, a computer program, and a computer-readable storage medium.

In each of the exemplary embodiments described above, although the example has been described in which the radiowave transmission area of wireless communicating apparatus 100, 2100 and external device 200 is divided into four sectors, a number of divisions is not limited to the number. For example, it is possible to divide the radiowave transmission area into a number of beam forming that is determined by the standard. However, it is preferable to be divided so that the area can be displayed on display 120 and recognized by the user, or so that terminal information can be operated.

In each of the exemplary embodiments described above, although the configuration has been described as the example in which the display area of display 120 is divided in a longitudinal (horizontal) direction of display 120 to match a dividing direction of the plurality of transmission directionalities, the configuration is not limited to the example. For example, when the dividing direction of the plurality of transmission directionalities is a short (vertical) direction of display 120, the display area of display 120 may be divided in the short (vertical) direction of display 120. Further, when directions of the plurality of transmission directionalities are defined by dividing the display area of display 120 in two-dimension of horizontal and vertical directions, the display area of display 120 may be divided two-dimensionally in a matrix shape. In this case, it is preferable to be divided so that the terminal information can be easily identified. Thus, in one imaging, a service can be executed with a greater number of external device 200.

In each of the exemplary embodiments described above, although the configuration has been described as the example in which one external device 200 is displayed in one display area of display 120, the configuration is not limited to the example. For example, when the plurality of external devices 200 is displayed in one display area, all external devices 200 that transmit the respective response signals may be displayed in the same display area. This increases options of external devices 200, and communication of data becomes possible.

In each of the exemplary embodiments described above, although the case has been described as the example in which the division number of the transmission directionality is equal to the division number of the display area of display 120, the configuration is not limited to the example. For example, the division number of the transmission directionality may be greater than the division number of the display area of display 120. As far as the terminal information can be displayed to external device 200 to be displayed on display 120, the division number of the transmission directionality may be any number.

In each of the exemplary embodiments described above, although wireless communicating apparatus 100 has been described as the example including image pick-up sensor 110 such as a camera, the configuration is not limited to the example. For example, wireless communicating apparatus 100 can be a pair of glasses including a configuration other than image pick-up sensor 110. In this case, in a direction seen by a person who wears the pair of glasses, wireless communicating apparatus 100 transmits the search signal sequentially to the directions of the plurality of transmission directionalities. Based on the response signal from external device 200 in which the reception quality is the best to the search signal, wireless communicating apparatus 100 displays the terminal information on lens divided into a plurality of display areas. Then, the user operates the terminal information displayed to execute a required service. Further, when the direction seen is changed, wireless communicating apparatus 100 re-selects the optimal direction of the transmission directionality, and moves the terminal information to the display area of external device 200 to be displayed. Thus, even when a positional relationship with external device 200 is changed, it is possible to execute the service without decreasing communication quality.

In each of the exemplary embodiments described above, the search timing may be executed by combining timing of wireless communicating apparatus 100 and timing of wireless communicating apparatus 2100 with each other. That is, it may be configured so that wireless communicating apparatus, while transmitting the search signal at a period of a beacon signal, further transmits the search signal when there is a movement of external device 200 on display 120.

In each of the exemplary embodiments described above, although as the terminal information, identification information of external device 200 and a service selection menu have been described as the example, the configuration is not limited to the example. For example, the terminal information may be any information as far as it is information about external device 200.

Since the above described exemplary embodiments are intended to illustrate the technique of the present disclosure, various modifications, substitutions, additions, omissions and the like can be performed within the scope of the claims or the scope of the equivalents of the claims.

What is claimed is:

1. A wireless communicating apparatus that performs wireless communication with an external device, the wireless communicating apparatus comprising:
a wireless communicating device having a plurality of transmission directionalities and capable of switching the transmission directionalities;
a display having a plurality of display areas corresponding to the transmission directionalities and displaying information about the external device; and
a controller that controls the wireless communicating device and the display, wherein
the controller allows
the wireless communicating device to transmit a search signal by switching the transmission directionalities and selects one of the transmission directionalities based on a response signal received from the external device, and
the display to display the information about the external device in one of the display areas corresponding to the transmission directionality selected.

2. The wireless communicating apparatus according to claim 1, wherein
a direction in which the transmission directionalities are switched and a direction in which the plurality of display areas is lined coincide with each other.

3. The wireless communicating apparatus according to claim 1, wherein
the response signal includes information about reception quality to the search signal, and
the controller selects the transmission directionality corresponding to the search signal in which the reception quality is the best.

4. The wireless communicating apparatus according to claim 1, wherein
the controller periodically performs a set of switching operation of the plural transmission directionalities to update display of the display.

5. The wireless communicating apparatus according to claim 1, further comprising a sensor that detects a motion of the wireless communicating apparatus, wherein
the controller, when the sensor detects the motion, switches the transmission directionalities to update display of the display.

6. The wireless communicating apparatus according to claim 1, further comprising an image pick-up sensor that acquires an image, wherein
an imaging area of the image pick-up sensor is included in a communication range in which there is the plurality of transmission directionalities.

7. The wireless communicating apparatus according to claim 6, wherein
the controller, when detecting a motion of the wireless communicating apparatus based on the image, switches the transmission directionalities to update display of the display.
